(19) United States
(12) Patent Application Publication
(10) Pub. No.: US 2006/0154801 A1
(43) Pub. Date: Jul. 13, 2006

(54) Protecting layer, composite for forming the same, method of forming the protecting layer, plasma display panel comprising the protecting layer

(76) Inventors: Min-Suk Lee, Suwon-si (KR); Jong-Seo Choi, Suwon-si (KR); Suk-Ki Kim, Suwon-si (KR); Jae-Hyuk Kim, Suwon-si (KR); Soon-Sung Suh, Suwon-si (KR)

Correspondence Address: ROBERT E. BUSHNELL, 1522 K STREET NW, SUITE 300, WASHINGTON, DC, 20005-1202, US

(21) Appl. No.: 11/328,107

(22) Filed: Jan. 10, 2006

(30) Foreign Application Priority Data
Jan. 11, 2005 (KR) 10-2005-0002430

(51) Int. Cl. C04B 35/04; H01J 17/00; H01J 9/24

(52) U.S. Cl. 501/108; 445/24; 313/581

(57) ABSTRACT

A protecting layer is formed of a magnesium oxide and at least one additional component selected from the group consisting of a copper component selected from copper and a copper oxide, a nickel component selected from nickel and a nickel oxide, a cobalt component selected from cobalt and a cobalt oxide, and an iron component selected from iron and an iron oxide; a composite for forming the protecting layer; a method of forming the protecting layer; and a plasma display panel including the protecting layer. The protecting layer, which is used in a PDP, protects an electrode and a dielectric layer from a plasma ion generated by a gaseous mixture of Ne and Xe, or He, Ne, and Xe, and discharge delay time and dependency of the discharge delay time on temperature can be decreased and sputtering resistance can be increased.

### CROSS-REFERENCE TO RELATED PATENT APPLICATIONS AND CLAIM OF PRIORITY

This application claims the benefit of Korean Patent Application No. 10-2005-0002430, filed on 11 Jan. 2005, in the Korean Intellectual Property Office, the disclosure of which is incorporated herein in its entirety by reference.

### BACKGROUND OF THE INVENTION

1. Field of the Invention

The present invention relates to a protecting layer, a composite for forming the same, a method of forming the protecting layer, and a plasma display panel including the protecting layer, and more particularly, to a protecting layer which is formed of a magnesium oxide, and at least one additional component selected from the group consisting of a copper component, a nickel component, a cobalt component, and an iron component in order to improve discharge delay time and sputtering resistance; a composite for forming the protecting layer; a method of forming the protecting layer; and a plasma display panel including the protecting layer.

2. Description of the Related Art

Plasma display panels (PDPs) can be used to form large screens easily, are self-emissive to thus have good display quality, and have quick response. In addition, PDPs can be formed in thin films, and thus, they, like LCDs, are suitable for a wall-mounted display.

In a plasma display panel, a discharge sustain electrode group is covered by a dielectric layer formed of glass, and the dielectric layer is covered by a protecting layer because, when the dielectric layer is directly exposed to a discharge space, discharge characteristics decrease and lifetime is shortened.

The use of a protecting layer of a PDP results in three advantages below.

First, the protecting layer protects an electrode and a dielectric. Even when there is the electrode or dielectric/electrode only, discharge may occur. However, when there is the electrode only, it is difficult to control a discharged current, and when there is the dielectric and the electrode only, the dielectric can be damaged by sputtering etching. Therefore, the dielectric must be coated with a protecting layer that has a strong resistance against plasma ions.

Second, the discharge starting voltage decreases. A physical value that is directly related to the discharge starting voltage is a secondary electron emission coefficient of a material for forming a protecting layer against plasma ions. As more secondary electrons are emitted from the protecting layer, the lower discharge starting voltage can be obtained. Thus, greater secondary electron emission coefficient of the material for forming the protecting layer is desirable.

Finally, the discharge delay time decreases. The discharge delay time is a physical value describing a phenomenon where discharge occurs a predetermined time after a voltage is supplied, and is a sum of a formation delay time (Tf) and a statistical delay time (Ts). Tf is a time interval between an applied voltage and a discharged current, and Ts is a statistical dispersion of the formation delay time. As the discharge delay time decrease, high speed addressing can be attained and thus a single scan can be used, a scan drive costs can be reduced, and more sub fields can be formed to be able to produce a PDP with high brightness and high quality image.

In consideration of such an advantage on use of a protecting layer, research for decreasing the discharge starting voltage and the discharge delay time by controlling a protecting layer of a PDP are being actively carried out. For example, Japanese Patent No. 2003-173738 discloses a protecting layer of a PDP formed of a magnesium oxide, as a main component, and at least one oxide selected from rear earth oxides. However, the use of a conventional protecting layer of a PDP fails to decrease the discharge starting voltage and the discharge delay time to a desired level. Accordingly, a protecting layer of PDP must be improved to obtain a PDP with long lifetime and high image quality.

### SUMMARY OF THE INVENTION

The present invention provides a protecting layer which is formed of a magnesium oxide, and at least one additional component selected from the group consisting of a copper component selected from copper and a copper oxide, a nickel component selected from nickel and a nickel oxide, a cobalt component selected from cobalt and a cobalt oxide, and an iron component selected from iron and iron oxides in order to improve a discharge starting voltage and a discharge delay time; a composite for forming the protecting layer; a method of forming the protecting layer; and a plasma display panel including the protecting layer.

According to an aspect of the present invention, there is provided a protecting layer which is formed of: a magnesium oxide; and at least one additional component selected from the group consisting of a copper component selected from copper and a copper oxide, a nickel component selected from nickel and a nickel oxide, a cobalt component selected from cobalt and a cobalt oxide, and an iron component selected from iron and an iron oxide.

According to another aspect of the present invention, there is provided a composite for forming a protecting layer, the composite including: a magnesium oxide derived from at least one magnesium-containing compound selected from a magnesium oxide and a magnesium salt; and at least one additional component selected from the group consisting of a copper component derived from at least one copper-containing compound selected from a copper oxide and a copper salt, a nickel component derived from at least one nickel-containing compound selected from a nickel oxide and a nickel salt, a cobalt component derived from at least one cobalt-containing compound selected from a cobalt oxide and a cobalt salt, and an iron component derived from at least one iron-containing compound selected from an iron oxide and an iron salt.

According to yet another aspect of the present invention, there is provided a method of forming a protecting layer, the method including: (a) homogenously mixing at least one magnesium-containing compound selected from a magnesium oxide and a magnesium salt, and at least one compound selected from the group consisting of at least one copper-containing compound selected from a copper oxide and a copper salt, at least one nickel-containing compound selected from a nickel oxide and a nickel salt, at least one cobalt-containing compound selected from a cobalt oxide and a cobalt salt, and at least one iron-containing compound selected from an iron oxide and an iron salt; (b) calcinating the mixture resulting from operation (a); (c) sintering the result of the calcination to form a composite for forming a protecting layer; and (d) forming the protecting layer using the composite for forming the protecting layer.

According to still another aspect of the present invention, there is provided a plasma display panel including the protecting layer.

According to a protecting layer according to the present invention, the discharge delay time is decreased, dependency of the discharge delay time on temperature is decreased, and sputtering resistance can be increased. Thus, a PDP of long lifetime and high brightness can be obtained.

### BRIEF DESCRIPTION OF THE DRAWINGS

A more complete appreciation of the present invention, and many of the above and other features and advantages of the present invention, will be readily apparent as the same becomes better understood by reference to the following detailed description when considered in conjunction with the accompanying drawings in which like reference symbols indicate the same or similar components, wherein:

FIG. 1 is a vertical sectional view of a pixel of a PDP according to an embodiment of the present invention in which an upper substrate and a lower substrate are rotated by 90°;

FIG. 2 illustrates graphs of discharge delay time with respect to temperature of a film formed by using a monocrystalline magnesium oxide film and a film formed by using a polycrystalline magnesium oxide;

FIG. 3 is a schematic view illustrating an auger neutralization theory describing emission of an electron from a solid by a gas ion;

FIG. 4 is an exploded perspective view of a PDP including a protecting layer according to an embodiment of the present invention;

FIGS. 5 through 7 are graphs of discharge delay time with respect of temperature of a discharge cell including a protecting layer according to an embodiment of the present invention;

FIG. 8 is a graph of discharge delay time with respect to temperature of a 42-inch SD panel including a protecting layer that is formed using a monocrystalline magnesium oxide; and

FIG. 9 is a graph of discharge delay time with respect to temperature of a 42-inch SD panel including a protecting layer according to an embodiment of the present invention.

### DETAILED DESCRIPTION OF THE INVENTION

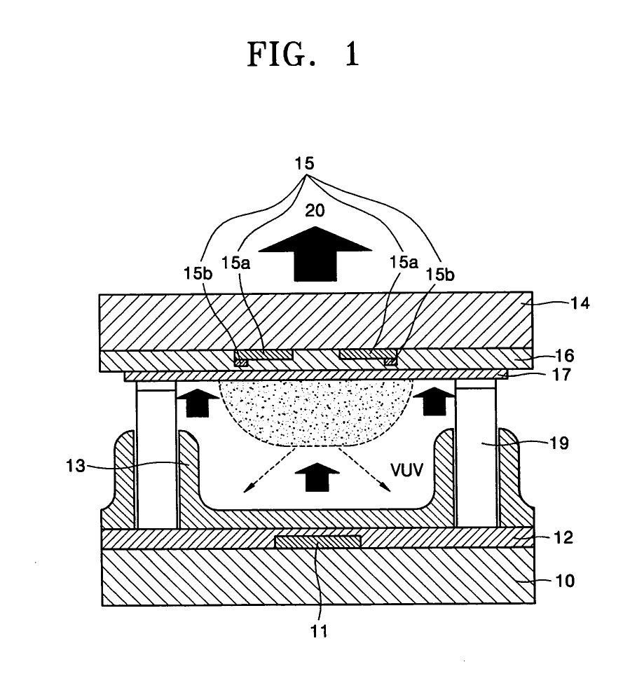

FIG. 1 illustrates a PDP pixel, among hundreds of thousands of PDP pixels. Referring to FIG. 1, a discharge sustain electrode group 15 includes a first electrode and a second electrode, which are paired, on a lower surface of a front substrate 14. The discharge sustain electrode group 15 is covered by a dielectric layer 16 formed of glass, and the dielectric layer 16 is covered by a protecting layer 17 because when the dielectric layer is directly exposed to a discharge space, discharge characteristics decrease and lifetime is shortened.

An address electrode 11, which is covered by a dielectric layer 12, is formed on an upper surface of a rear substrate 10. The front substrate 14 is separated from the rear substrate 10 in a distance of a few tens μm, and the space formed between the front substrate 14 and the rear substrate 10 is filled with a gaseous mixture of Ne and Xe or a gaseous mixture of He, Ne, and Xe, which generates ultraviolet rays, with a pressure (for example, 450 torr). The Xe gas generates vacuum ultraviolet rays (Xe ion: 147 nm resonance reflected pulse, Xe₂: 173 nm resonance reflected pulse.)

A protecting layer according to an embodiment of the present invention may be formed of a magnesium oxide, and at least one additional component selected from the group consisting of a copper component selected from copper and a copper oxide, a nickel component selected from nickel and a nickel oxide, a cobalt component selected from cobalt and a cobalt oxide, and an iron component selected from iron and an iron oxide. The additional component, which is artificially added to the protecting layer by doping or the like, is different from natural impurities, which is well known to those of ordinary skill in the art.

The magnesium oxide of the protecting layer is a polycrystalline magnesium oxide. The magnesium oxide of the protecting layer can be formed using a monocrystalline MgO or a polycrystalline MgO.

The monocrystalline MgO that is used to form a protecting layer may be obtained from a high purity sintered MgO. The high purity sintered MgO grows to a diameter of 2-3 inches in an arc furance and is processed in a pellet of 3 to 5 mm to be used for depositing of a protecting layer. The monocrystalline MgO typically contains a certain amount of an impurity. Table 1 shows an inductively coupled plasma emission spectrometer (ICP) analysis results that include kinds of the impurity that may exist in a typical monocrystalline MgO and the amounts thereof.

TABLE 1

| Impurity | Al | Ca | Fe | Si | K | Na | Zr | Mn | Cr | Zn | B | Ni |
|---|---|---|---|---|---|---|---|---|---|---|---|---|
| Amount (ppm) | 80 | 220 | 70 | 100 | 50 | 50 | <10 | 10 | 10 | 10 | 20 | <10 |
| (ppm) | | | | | | | | | | | | |

Examples of the impurity that is typically contained in the monocrystalline MgO may include Al, Ca, Fe, Si, K, Na, Zr, Mn, Cr, Zn, B, Ni, and the like. Among these, Al, Ca, Fe, and Si dominate the impurity. After a monocrystalline MgO with the impurity is deposited in a form of a thin film, the amount of the impurity can be controlled to a few hundreds ppm to improve the characteristics of the thin film. However, when a protecting layer is formed using the monocrystalline MgO, the manufacturing process for the protecting layer is complex and it is difficult to control the concentration of the impurity. In addition, the protecting layer that is formed using the monocrystalline MgO does not satisfy discharge characteristics required in a PDP.

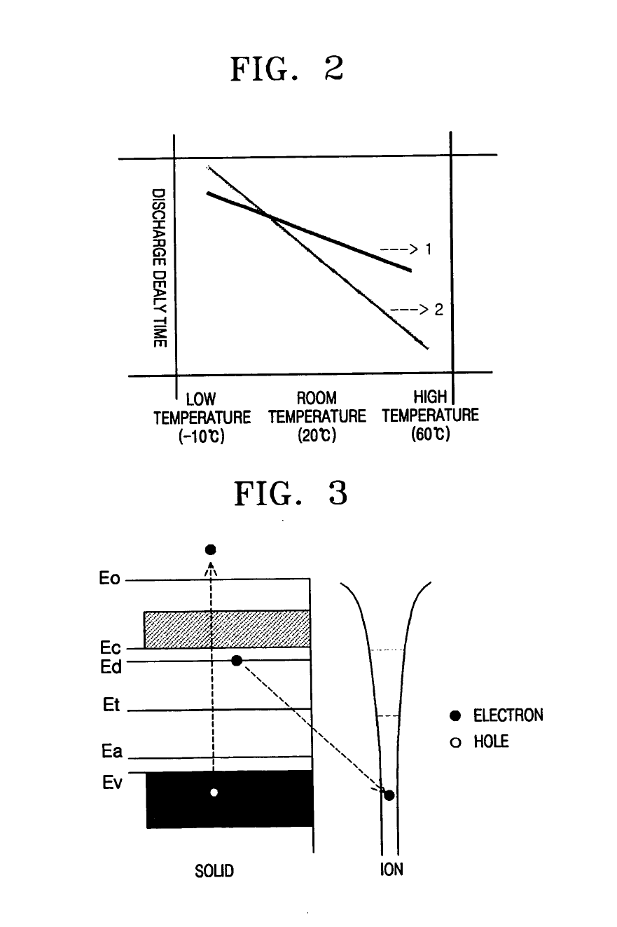

FIG. 2 shows Graph 1 of a discharge delay time of a film formed using a monocrystalline MgO and Graph 2 of a discharge delay time of a film formed using a polycrystalline MgO. Referring to Graph 1 of the discharge delay time of the film formed using the monocrystalline MgO, although dependency on temperature is relatively low, the discharge delay time is not suitable for a single scan.

On the other hand, referring to Graph 2 of the film formed using the polycrystalline MgO, the discharge starting time is significantly decreased, compared with Graph 1 of the discharge delay time of the film formed using the monocrystalline MgO, but dependency of the discharge delay time on temperature is relatively high. However, since the polyicrystalline MgO has a greater deposition speed than the monocrystalline MgO, a process index can be decreased. In addition, less discharge delay time results in high speed addressing, and thus the scan drive costs can be decreased by using a single scan, and more sub fields can be formed to improve brightness and image quality. That is, less discharge delay time results in realization of a single scan of a high density (HD) panel, more sustains result in higher brightness, and more sub fields comprising a TV-field result in a decrease of dynamic false contour.

Therefore, the protecting layer according to an embodiment of the present invention preferably contains a polycrystalline magnesium oxide.

The protecting layer is formed of the magnesium oxide described above, and at least one additional component selected from the group consisting of a copper component selected from copper and a copper oxide, a nickel component selected from nickel and a nickel oxide, a cobalt component selected from cobalt and a cobalt oxide, and an iron component selected from iron and an iron oxide. That is, the protecting layer according to an embodiment of the present invention is formed of, in addition to the magnesium oxide, at least one additional component selected from the group consisting of the copper component, the nickel component, the cobalt component, and the iron component. For example, the protecting layer according to an embodiment of the present invention can be formed of the magnesium oxide and the copper component, of the magnesium oxide and the nickel component, of the magnesium oxide and the cobalt component, of the magnesium oxide and the iron component, or of the magnesium oxide, the copper component, and the nickel component.

The protecting layer can emit secondary electrons by gaseous ions, and as more secondary ions are emitted, the discharge starting voltage can be improved.

A mechanism in which a secondary electron is emitted from a solid by collision of a gaseous ion and the solid can be explained using an auger neutralization theory. According to the auger neutralization theory, when the gaseous ion collides with the solid, an electron moves from the solid to the gaseous ion so that a neutral gas is generated and the solid has a hole. This relationship can be represented by
Eₖ=Eₗ−2(E_{g}+X) (1)
where Eₖ is an energy generated when an electron is emitted from the solid when the solid collides with a gaseous ion, Eₗ is an ionization energy of a gas, E_{g} is a band gap energy of the solid, and χ is electron affinity.

The auger neutralization theory and Formula 1 can be applied to a protecting layer and a discharge gas of a PDP. When a voltage is supplied to a PDP pixel, seed electrons generated by a cosmic ray or an ultraviolet ray collides with the discharge gas to generate a discharge gas ion. The discharge gas ion collides with the protecting layer so that a secondary electron is emitted from the protecting layer, that is, discharge occurs.

Table 2 below shows a resonance emission wavelength and an ionization voltage, that is, the ionization energy of a discharge gas of an inert gas that can be used as a discharge gas. When the protecting layer is formed of MgO, E_{g} of Formula 1 is 7.7 eV that is the band gap energy of MgO and χ is 0.5. Meanwhile, Xe that generates a vacuum ultraviolet ray with the longest wavelength is suitable to increase a photo conversion efficiency of a fluorescence of the PDP. However, when Xe is used, the ionization voltage, that is, Eₗ is 12.13 eV and, when Eₗ of 12.13 eV is given to Formula 1, Eₖ that is an energy generated when an electron is emitted from the protecting layer formed of MgO is less than 0. As a result, a discharge voltage is very high. Accordingly, a gas with high ionization voltage must be used to decrease the discharge voltage. According to Formula 1, Eₖ for He is 8.19 eV and Eₖ for Ne is 5.17 eV, and thus, the use of He or Ne is desirable to decrease the discharge starting voltage. However, when the He gas is used in the PDP discharge, a serious plasma etching occurs due to high momentum of He.

TABLE 2
Inert Gas and Ionization Energy

| | | | | meta stable level | | |
|---|---|---|---|---|---|---|
| | Resonance Level Excitation | | | excitation | | |
| | | Wave- | | | | Ionization |
| | Voltage | length | Lifetime | Voltage | Lifetime | Voltage |
| Gas | (V) | (nm) | (ns) | (V) | (ns) | (V) |
| He | 21.2 | 58.4 | 0.555 | 19.8 | 7.9 | 24.59 |
| Ne | 16.54 | 74.4 | 20.7 | 16.62 | 20 | 21.57 |
| Ar | 11.61 | 107 | 10.2 | 11.53 | 60 | 15.76 |
| Kr | 9.98 | 124 | 4.38 | 9.82 | 85 | 14.0 |
| Xe | 8.45 | 147 | 3.79 | 8.28 | 150 | 12.13 |

In consideration of such description, in order to increase the number of the emitted secondary electron, E_{g} that is the band gap energy of the protecting layer can be changed, instead of increasing Eₗ by controlling the discharge gas. The protecting layer according to an embodiment of the present invention is designed based on the change of E_{g}. That is, in addition to the magnesium oxide, at least one additional component selected from the copper component, the nickel component, the cobalt component, and the iron component is used to form the protecting layer, to control the band gap energy of the protecting layer.

FIG. 3 illustrates an auger neutralization theory describing emission of an electron from a solid by a gaseous ion. MgO that is used to form a protecting layer of a PDP is a wide band-gap material like diamond, and has very low or a negative electron affinity. The magnesium oxide containing at least one additional component selected from the copper component, the nickel component, the cobalt component, and the iron component according to an embodiment of the present invention, has a donor level (E_{d}), an acceptor level (Eₐ), and a deep level (Eₜ) formed at the same time by impurity doping between a valence band (Eᵥ) and a conduction band (E_{c}). As a result, the protecting layer according to an embodiment of the present invention has a band gap shrinkage effect. Accordingly, the protecting layer may have a lower E_{g} than a non-doped MgO having 7.7 eV of E_{g}. Therefore, even when the amount of Xe used as the discharge gas is increased, a desired Eₖ can be obtained.

The protecting layer according to an embodiment of the present invention contains at least one additional component selected from the copper component, the nickel component, the cobalt component, and the iron component, to have various impurity levels, such as the donor level, the acceptor level, the deep level, and the like, between the MgO band gaps so as to obtain the band gap shrinkage effect.

In detail, the copper component, the nickel component, the cobalt component, and the iron component, which can be used as the additional component, have two valence electrons and thus exist in two ionic states. That is, Cu can exist in Cu⁺ and Cu²⁺, Ni can exist in Ni²⁺ and Ni³⁺, Co can exist in Co²⁺ and Co³⁺, and Fe can exist in Fe²⁺ and Fe³⁺. Accordingly, in the copper component, the nickel component, the cobalt component, and the iron component, electrons can hop between their two states described above, electron mobility improves, and the quick emission of an electron from the bulk to the surface of the protecting layer can be facilitated. The doping with the copper component, the nickel component, the cobalt component, or the iron component is expected to bring about similar effects.

The suitability of the copper component, the nickel component, the cobalt component, and the iron component as the additional component of the protecting layer according to an embodiment of the present invention can be more clarified by identifying unsuitableness of other transition atoms. For example, Ti, V, Cr, Mn, Nb, Ta, Mo, W, and the like have valence electrons of three or greater, and thus, they can exist in at least three ionic states. When the protecting layer is doped with these atoms, defect states are in disorder and the electron hoping effect due to the additional component according to an embodiment of the present invention described above does not occur. Zr, Hf, and the like exist in the valence electron of 2+ only, and thus, the electron hoping effect due to the additional component according to an embodiment of the present invention described above does not occur. Tc, Re, Ru, Os, Rh, Ir, and the like are not suitable for the protecting layer because of their metallic properties. Pd, Pt, Ag, Au, and the like are not suitable for the protecting layer because they are noble metals.

Among the additional components, when Cu²⁺ is used, energy levels formed by the impurity are not formed because Cu²⁺ and an Mg ion have the same valence electron. When Cu¹⁺ is used, the acceptor level is formed. As a result, the electron hoping between these two ionic states occurs as described above. In addition, when the protecting layer is exposed to an electric field, the stress due to the electric field can be decreased. Due to these effects resulting from the use of the copper component, the sputtering resistance of the protecting layer can be improved.

According to another embodiment of the present invention, the protecting layer may be further formed of at least one aluminum component selected from aluminum and an aluminum oxide, in addition to the Mg oxide and the additional component. The aluminum component generates a donor level and/or an acceptor level (for example, A1³⁺ ion) so that electron emission can be improved.

The amount of the additional component may be in the range of 5.0×10⁻⁵ to 1.0×10⁻³ parts by weight, preferably, 5.0×10⁻⁵ to 6.0×10⁻⁴ parts by weight, more preferably, 5.0×10⁻⁵ to 4.0×10⁻⁴ parts by weight based on 1 part by weight of the magnesium oxide. When the amount of the additional component is less than 5.0×10⁻⁵ parts by weight based on 1 part by weight of the magnesium oxide, the electron emission effect due to electron hoping of the additional component is very small. When the amount of the additional component is greater than 1.0×10⁻³ parts by weight based on 1 part by weight of the magnesium oxide, the insulating property of the protecting layer may decrease due to the increase of conductance of the protecting layer.

When the additional component contains the copper component, the amount of the copper component may be in the range of 5.0×10⁻⁵ to 6.0×10⁻⁴ parts by weight, preferably, 5.0×10⁻⁵ to 4.0×10⁻⁴ parts by weight, and more preferably, 2.0×10⁻⁴ parts by weight based on 1 part by weight of the magnesium oxide. When the amount of the copper component is less than 5.0×10⁻⁵ parts by weight based on 1 part by weight of the magnesium oxide, the electron emission effect due to electron hoping of the copper component is very small. When the amount of the copper component is greater than 6.0×10⁻⁴ parts by weight based on 1 part by weight of the magnesium oxide of the protecting layer, the insulating property of the protecting layer may decrease due to the increase of conductance of the protecting layer.

When the additional component contains the nickel component, the amount of the nickel component may be in the range of 1.0×10⁻⁴ to 6.0×10⁻⁴ parts by weight, preferably, 1.0×10⁻⁴ to 5.0×10⁻⁴ parts by weight, and more preferably, 2.0×10⁻⁴ parts by weight based on 1 part by weight of the magnesium oxide. When the amount of the nickel component is less than 1.0×10⁻⁴ parts by weight based on 1 part by weight of the magnesium oxide, the electron emission effect due to electron hoping of the nickel component is very small. When the amount of the nickel component is greater than 6.0×10⁻⁴ parts by weight based on 1 part by weight of the magnesium oxide of the protecting layer, the insulating property of the protecting layer may decrease due to the increase of conductance of the protecting layer.

When the additional component contains the cobalt component or the iron component, the amount range of the cobalt or iron component may be the same as the amount range of the nickel component.

When the protecting layer according to an embodiment of the present invention is further formed of the aluminum component, the amount of aluminum may be in the range of 1.0×10⁻⁴ to 6.0×10⁻⁴ parts by weight, preferably, 1.0×10⁻⁴ to 5.0×10⁻⁴ parts by weight, and more preferably, 2.0×10⁻⁴ parts by weight based on 1 part by weight of the magnesium component. When the amount of the aluminum component is less than 1.0×10⁻⁴ parts by weight based on 1 part by weight of the magnesium oxide, the acceptor level or donor level formation effect of the magnesium oxide described above is very small. When the amount of the aluminum component is greater than 6.0×10⁻⁴ parts by weight based on 1 part by weight of the magnesium oxide, the insulating property of the protecting layer may decrease due to the increase of conductance of the protecting layer.

The discharge delay time of the protecting layer according to an embodiment of the present invention described above may be in the range of 800 ns to 1000 ns, and preferably, 850 ns to 950 ns. Such discharge delay time of the protecting layer according to an embodiment of the present invention is significantly shorter than the discharge delay time of about 1250 ns of a conventional protecting layer.

The discharge delay time of the protecting layer according to an embodiment of the present invention will be described in detail in Example.

A method of forming a protecting layer according to an embodiment of the present invention includes: (a) homogenously mixing at least one magnesium-containing compound selected from a magnesium oxide and a magnesium salt, and at least one compound selected from the group consisting of at least one copper-containing compound selected from a copper oxide and a copper salt, at least one nickel-containing compound selected from a nickel oxide and a nickel salt, at least one cobalt-containing compound selected from a cobalt oxide and a cobalt salt, and at least one iron-containing compound selected from an iron oxide and an iron salt; (b) calcinating the mixture resulting from operation (a); (c) sintering the result of the calcination to form a composite for forming a protecting layer; and (d) forming the protecting layer using the composite.

The magnesium salt may be selected from MgCO₃ and Mg(OH)₂, and preferably, Mg(OH)₂.

The copper salt may be selected from CuCl₂, Cu(NO₃)₂ and CuSO₄, and preferably, Cu(NO₃)₂.

The nickel salt may be selected from NiCl₂, Ni(NO₃)₂ and NiSO₄, and preferably, Ni(NO₃)₂.

The cobalt salt may be selected from CoCl₂, Co(NO₃)₂ and CoSO₄, and preferably, Co(NO₃)₂.

The iron salt may be selected from FeCl₂, Fe(NO₃)₂ and FeSO₄, and preferably, Fe(NO₃)₂.

Meanwhile, in operation of the mixing, at least one aluminum-containing compound selected from an aluminum oxide and an aluminum salt can be added. The aluminum salt may be one of AlCl₃, Al(NO₃)₃ and Al₂(SO₄)₃, preferably, Al(NO₃)₃.

The mixing may be performed using a flux. The flux can be any material that can dissolve the magnesium-containing compound, the copper-containing compound, the nickel-containing compound, the cobalt-containing compound, the ion-containing compound, and/or the aluminum-containing compound. In detail, the flux can be MgF₂, AlF₃, or the like, but is not limited thereto.

Then, the compounds contained in the resulting mixture are aggregated by calcination. The calcination may be performed at a temperature of 400° C. to 1000° C., preferably, 700° C. to 900° C. The time for the calcination may be in the range of 1 to 10 hours, preferably, 2 to 5 hours. When the temperature and time for the calcination are less than 400° C. and 1 hour, respectively, aggregation effects are small. When the temperature and time for the calcination are greater than 1000° C. and 10 hours, respectively, the additional component and the aluminium component can be damaged.

Then, in order to crystallize the result of the calcination, the result of the calcination is sintered to form a composite for forming a protecting layer. In this case, the result of the calcination is formed in a pellet form and then sintered. The sintering can be performed at a temperature of 1000° C. to 1750° C., preferably, 1500° C. to 1700° C. The time for the sintering may be in the range of 1 to 10 hours, preferably, 3 to 5 hours. When the temperature and time for the sintering is less than 1000° C. and 1 hour, respectively, the result of the calcination may not be sufficiently crystallized. When the temperature and time for the sintering is greater than 1750° C. and 10 hours, respectively, the additional component and/or the aluminum component can be damaged.

Through the sintering, the composite for the protecting layer can be attained. In the present invention, “composite for forming a protecting layer” is obtained by mixing starting materials for forming the protecting layer (that is, a Mg-containing compound and at least one of a Cu-containing compound, a Ni-containing compound, a Co-containing compound, a Fe-containing compound, and optionally an Al-containing compound (when the protecting layer is further formed of an Al component), calcinating the resulting mixture, and sintering the result of the calcination, and the obtained composite for forming the protecting layer becomes the protecting layer by various methods, for example, deposition in a subsequent process.

As described above, the composite for forming the protecting layer according to an embodiment of the present invention may contain a magnesium oxide derived from at least one magnesium-containing compound selected from a magnesium oxide and a magnesium salt, and at least one additional component selected from the group consisting of a copper component derived from at least one copper-containing compound selected from a copper oxide and a copper salt, a nickel component derived from at least one nickel-containing compound selected from a nickel oxide and a nickel salt, a cobalt component derived from at least one cobalt-containing compound selected from a cobalt oxide and a cobalt salt, and an iron component derived from at least one iron-containing compound selected from an iron oxide and an iron salt.

The term “a magnesium oxide derived from at least one magnesium-containing compound selected from a magnesium oxide and a magnesium salt” indicates a magnesium oxide which has different physical and/or chemical properties from the magnesium-containing compound that is a starting material, as a result of calcination and sintering described above. The “copper component”, “nickel component”, “cobalt component”, and “iron component” can be understood based on the same manner.

The composite for forming the protecting layer may further include an aluminum component derived from at least one aluminum-containing compound selected from an aluminum oxide and an aluminum salt.

The magnesium salt for the magnesium-containing compound may be selected from MgCO₃ and Mg(OH)₂. The copper salt for the copper-containing compound may be selected from CuCl₂, Cu(NO₃)₂ and CuSO₄. The nickel salt for the nickel-containing compound may be selected from NiCl₂, Ni(NO₃)₂ and NiSO₄. The cobalt salt may be selected from CoCl₂, Co(NO₃)₂ and CoSO₄. The iron salt for the iron-containing compound may be selected from FeCl₂, Fe(NO₃)₂ and FeSO₄.

Then, the protecting layer is formed using the composite for forming the protecting layer. A method of forming the protecting layer is not limited, and can be any method that is known in the art. The method can be a chemical vapor deposition (CVD) method, an e-beam deposition method, an ion-plating method, a sputtering method, or the like, but is not limited thereto. Thus, the protecting layer, which includes: a magnesium oxide; and at least one additional component selected from the group consisting of a copper component selected from copper and a copper oxide, a nickel component selected from nickel and a nickel oxide, a cobalt component selected from cobalt and a cobalt oxide, and an iron component selected from iron and an iron oxide, is formed.

The protecting layer according to an embodiment of the present invention can be used in a gas discharge display device, in particular, in a PDP. The PDP may include a transparent front substrate; a rear substrate that is disposed parallel to the front substrate; barrier ribs which partition emission cells and are interposed between the front substrate and the rear substrate; address electrodes which extends throughout emission cells disposed in a predetermined direction and are covered by a rear dielectric layer; a fluorescent layer disposed in the emission cell; pairs of sustain electrodes which extend perpendicular to the direction in which the address electrode and are covered by a front dielectric layer; the above-described protecting layer formed below the front dielectric layer; and a discharge gas in the emission cell.

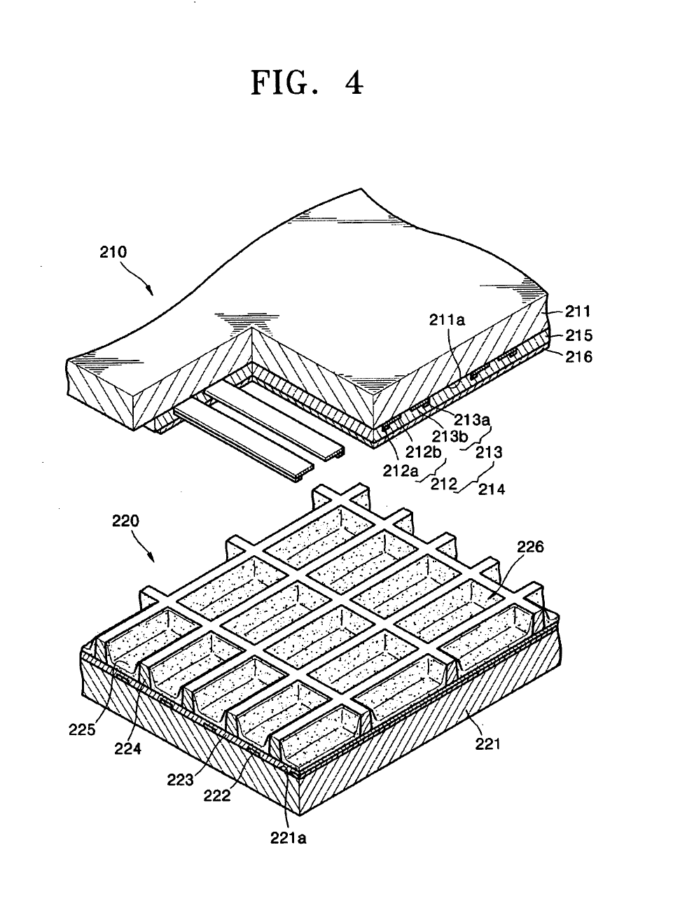

FIG. 4 is an exploded perspective view of a PDP 200 according to an embodiment of the present invention.

Referring to FIG. 4, a front panel 210 includes a front substrate 211; pairs of sustain electrodes 214, each pair of sustain electrodes which includes an Y electrode 212 and an X electrode 213 and is formed on a rear surface 211a of the front substrate 211; a front dielectric layer 215 covering the pairs of sustain electrodes; and a protecting layer 216 which is formed of a magnesium oxide and at least one additional component selected from the group consisting of at least one copper component selected from copper and a copper oxide, at least one nickel component selected from nickel and a nickel oxide, at least one cobalt component selected from cobalt and a cobalt oxide, and at least one iron component selected from iron and an iron component and covers the front dielectric layer 215. The protecting layer 216 is already described in detail above. The Y electrode 212 includes a transparent electrode 212b and a bus electrode 212a, and the X electrode 213 includes a transparent electrode 213b and a bus electrode 213a. The transparent electrodes 212b and 213b are formed of ITO or the like. The bus electrodes 212a and 213a are formed of a highly conductive metal.

A rear panel 220 includes a rear substrate 221, address electrodes 222 which are disposed perpendicular to the pairs of sustain electrodes on a front surface 221a of the front substrate 221, a rear dielectric layer 223 covering the address electrodes, barrier ribs 224 which partition emission cells 226 on the rear dielectric layer 223, and a fluorescent layer 225 disposed in the emission cell. The discharge gas in the emission cell can be a gaseous mixture prepared by mixing Ne and at least one gas selected from Xe, N₂ and Kr. Alternatively, the discharge gas in the emission cell can be a gaseous mixture prepared by mixing Ne and at least two gases selected from Xe, He, N₂, and Kr.

The protecting layer according to the present invention decreases the discharge delay time and dependency of the discharge delay time on temperature. As a result, the protecting layer can be used with 2-membered gaseous mixture of Ne and Xe. In general, as the amount of Xe increases, better brightness can be obtained. In addition, the protecting layer has excellent sputtering resistance against a three-membered gaseous mixture of Ne, Xe and He, and thus, the lifetime of the device can be increased. The addition of He is to compensate an increase of the discharge voltage. The present invention provides a protecting layer which decreases a degree of an increase of the discharge voltage with respect to the amount of Xe and satisfies the discharge delay time required for a single scan.

The present invention will be described in further detail with reference to the following examples. These examples are for illustrative purposes only and are not intended to limit the scope of the present invention.

### EXAMPLES

### Manufacture Example 1

Manufacture of Discharge Cell

MgO and Cu(NO₃)₂, of which amounts were controlled such that the amount of Cu was 5.0×10⁻⁵ g based on 1 g of the magnesium oxide, were mixed by stirring for 5 hours or greater in a mixer to produce a homogeneous mixture. MgF₂ as a flux was added to the mixture, and the result was stirred and heat treated at 900° C. for 5 hours in a melting pot. The heat treated result was compressively molded in a form of a pellet, and heat treated at 1650° C. for 3 hours. As a result, a composite for forming a protecting layer, in which the amount of Cu was 5.0×10⁻⁵ g based on 1 g of the magnesium oxide, was prepared.

Meanwhile, an Ag electrode with a predetermined pattern was formed on a glass (PD 200 Glass) with a size of 22.5×35×3 mm. Subsequently, the Ag electrode was covered with a PbO glass to form a PbO dielectric layer with a thickness of about 30 μm to 40 μm. The composite for forming a protecting layer was deposited on the PbO dielectric layer to form the protecting layer with a thickness of 700 nm. This process was repeated one more time so that two substrates including protecting layers were prepared.

These two substrates were arranged such that the protecting layers of the substrates face each other, and a spacer was disposed between two substrates to form a cell gap of about 200 μm. The result was installed in a vacuum chamber and purged with Ar gas of 500 torr four times such that the pressure of the inside of the cell was 2×10⁻⁶ torr. Then, a discharge gas of 95% Ne and 5% Xe was injected to the cell to obtain a discharge cell including the protecting layer according to the present invention. The resulting discharge cell will be referred to as Sample 1. It was identified that the amount of Cu of the protecting layer of Sample 1 was 5.0×10⁻⁵ g based on 1 g of the magnesium oxide, which was measured using a secondary ion mass spectroscopy (SIMS) analysis (that is, the amount of Cu was 5 wtppm based on 1 g of the magnesium oxide.)

Measurement of Amount of Cu of Protecting Layer

The amount of Cu of the protecting layer was measured using SIMS. First, in order to minimize exposure of the protecting layer of Sample 1 to the atmosphere, Sample 1 was placed in a purge system, and a part of the protecting layer of Sample 1 was collected and the collected part was installed in a sample holder for the SIMS analysis. Maintaining the purge state, the sample holder was placed in a preparation chamber of the SIMS apparatus, the preparation chamber was placed in an experimental chamber by pumping, and the amount of Cu was quantitatively measured using an oxygen ion gun to obtain a depth profile graph. This process was adopted in consideration of the fact that Cu is prone to be positively ionized than negatively ionized. This process was repeated using a standard sample, of which Cu of the MgO layer had a reference amount, to obtain a depth profile graph of the standard sample having Cu with the known amount. Analysis conditions are shown in Table 4 in detail.

TABLE 4

| | | |
|---|---|---|
| Primary ion beam | Energy | 5 ke V |
| | Current | 500 Na |
| | Raster size | 500 μm × 500 μm |
| Secondary Optics | Positive Mode | |
| Neutralization | Electron gun | |

The depth profile graphs of the standard sample and Sample 1 according to the present invention were measured using the following method to identify the amount of Cu of Sample 1. First, referring to the depth profile graph of the standard sample, a time scale of the X-axis was converted to a depth scale. At this time, the depth of the analyzed crater was measured using a surface profile and converted to a sputter rate. Then, the standard sample was normalized using the Mg component that is a matrix component of the standard sample, and a relative sensitive factor (RSF) was obtained using a dose value supplied from the standard sample.

Meanwhile, the depth profile graph of Sample 1 was measured in the same manner as above used to measure the depth profile graph of the standard sample. That is, the time scale of the X-axis was converted to the depth scale. Then, Sample 1 was normalized using the Mg component that is a matrix component of Sample 1. Then, the depth profile graph of the resulting Sample 1 was multiplied by the RSF obtained from the standard sample, and then a region as large as the thickness of the protecting layer of Sample 1 and a background were set and integrated. As a result, the amount of Cu of the protecting layer of Sample 1 was obtained.

As a result of SIMS analysis, it was identified that the amount of Cu of the protecting layer of Sample 1 was 5.0×10⁻⁵ g based on 1 g of the magnesium oxide (that is, the amount of Cu was 50 ppm based on 1 g of the magnesium oxide.)

### Manufacture Example 2

A discharge cell was produced in the same manner as in Manufacture Example 1, except that MgO and Cu(NO₃)₂, of which amounts were controlled such that the amount of Cu was 1.0×10⁻⁴ g based on 1 g of magnesium oxide, were mixed to form a composite for forming a protecting layer, and ultimately, a protecting layer, of which the amount of Cu was 1.0×10⁻⁴ g based on 1 g of the magnesium oxide (that is, the amount of Cu was 100 ppm based on 1 g of the magnesium oxide), was obtained. The discharge cell will be referred to Sample 2.

### Manufacture Example 3

A discharge cell was produced in the same manner as in Manufacture Example 1, except that MgO and Cu(NO₃)₂, of which amounts were controlled such that the amount of Cu was 2.0×10⁻⁴ g based on 1 g of magnesium oxide, were mixed to form a composite for forming a protecting layer, and ultimately, a protecting layer, of which the amount of Cu was 2.0×10⁻⁴ g based on 1 g of the magnesium oxide (that is, the amount of Cu was 200 ppm based on 1 g of the magnesium oxide), was obtained. The discharge cell will be referred to Sample 3.

### Manufacture Example 4

A discharge cell was produced in the same manner as in Manufacture Example 1, except that MgO and Cu(NO₃)₂, of which amounts were controlled such that the amount of Cu was 4.0×10⁻⁴ g based on 1 g of magnesium oxide, were mixed to form a composite for forming a protecting layer, and ultimately, a protecting layer, of which the amount of Cu was 4.0×10⁻⁴ g based on 1 g of the magnesium oxide (that is, the amount of Cu was 400 ppm based on 1 g of the magnesium oxide), was obtained. The discharge cell will be referred to Sample 4.

### Manufacture Example 5

A discharge cell was produced in the same manner as in Manufacture Example 1, except that MgO and Cu(NO₃)₂, of which amounts were controlled such that the amount of Cu was 6.0×10⁻⁴ g based on 1 g of magnesium oxide, were mixed to form a composite for forming a protecting layer, and ultimately, a protecting layer, of which the amount of Cu was 6.0×10⁻⁴ g based on 1 g of the magnesium oxide (that is, the amount of Cu was 600 ppm based on 1 g of the magnesium oxide), was obtained The discharge cell will be referred to Sample 5.

### Measurement Example 1

### Discharge Delay Time of Samples 1 through 5

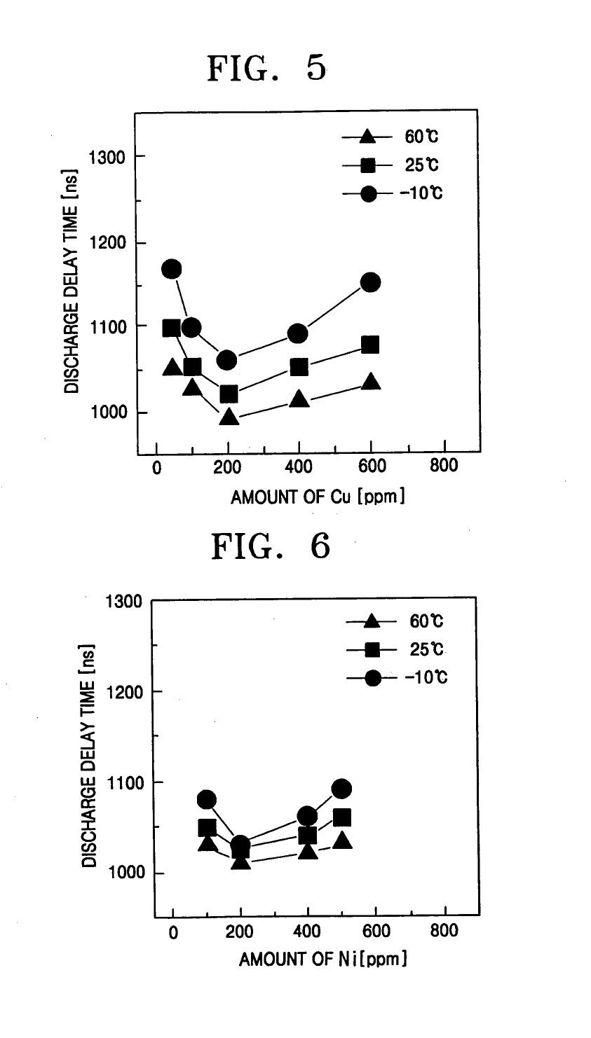

The discharge delay times (unit: ns) with respect to temperature of Samples 1, 2, 3, 4 and 5 were measured and the results are shown in FIG. 5.

The discharge delay time was measured using a Tektronix Oscilloscope, a Trek Amplifier, an NF Function Generator, a high vacuum chamber, a Peltier device, an I-V power source, and a LCR meter. First, Sample 1 was connected to the Tektronix oscilloscope, and its discharge starting voltage and discharge delay time were measured at −10° C., 25° C. and 60° C., respectively. The discharge starting voltage was measured using a sinuous wave of 2 kHz, and the discharge delay time was measured using a square wave of 2 kHz. This process was repeated using Samples 2, 3, 4 and 5, respectively.

Referring to FIG. 5, graphs represented by -▴-, -▪- and -●- illustrates discharge delay times at 60° C., 25° C. and −10° C., respectively.

Samples 1 through 5 according to the present invention had excellent discharge delay time and dependency of the discharge delay time on temperature. In particular, when the amount of Cu was 200 ppm, that is, when Sample 3 was used, the discharge delay time at 60° C. was great at low temperatures but improved to about 990 ns at high temperature.

### Manufacture Example 6

A discharge cell was produced in the same manner as in Manufacture Example 1, except that MgO and Ni(NO₃)₂, of which amounts were controlled such that the amount of Ni was 1.0×10⁻⁴ g based on 1 g of magnesium oxide, were mixed to form a composite for forming a protecting layer, and ultimately, a protecting layer of which the amount of Ni was 1.0×10⁻⁴ g based on 1 g of the magnesium oxide (that is, the amount of Ni was 100 ppm based on 1 g of the magnesium oxide) was obtained. Meanwhile, the amount of Ni was measured in the same manner as in Manufacture Example 1 that was used to measure the amount of Cu, and the result was 100 ppm. The discharge cell will be referred to as Sample 6.

### Manufacture Example 7

A discharge cell was produced in the same manner as in Manufacture Example 6, except that MgO and Ni (NO₃)₂, of which amounts were controlled such that the amount of Ni was 2.0×10⁻⁴ g based on 1 g of magnesium oxide, were mixed to form a composite for forming a protecting layer, and ultimately, a protecting layer, of which the amount of Ni was 2.0×10⁻⁴ g based on 1 g of the magnesium oxide (that is, the amount of Ni was 200 ppm based on 1 g of the magnesium oxide), was obtained. The discharge cell will be referred to Sample 7.

### Manufacture Example 8

A discharge cell was produced in the same manner as in Manufacture Example 6, except that MgO and Ni (NO₃)₂, of which amounts were controlled such that the amount of Ni was 4.0×10⁻⁴ g based on 1 g of magnesium oxide, were mixed to form a composite for forming a protecting layer, and ultimately, a protecting layer, of which the amount of Ni was 4.0×10⁻⁴ g based on 1 g of the magnesium oxide (that is, the amount of Ni was 400 ppm based on 1 g of the magnesium oxide), was obtained. The discharge cell will be referred to Sample 8.

### Manufacture Example 9

A discharge cell was produced in the same manner as in Manufacture Example 6, except that MgO and Ni (NO₃)₂, of which amounts were controlled such that the amount of Ni was 5.0×10⁻⁴ g based on 1 g of magnesium oxide, were mixed to form a composite for forming a protecting layer, and ultimately, a protecting layer, of which the amount of Ni was 5.0×10⁻⁴ g based on 1 g of the magnesium oxide (that is, the amount of Ni was 500 ppm based on 1 g of the magnesium oxide), was obtained. The discharge cell will be referred to Sample 9.

### Measurement Example 2

### Discharge Delay Time of Samples 6 through 9

The discharge delay times (unit: ns) with respect to temperature of Samples 6, 7, 8, and 9 were measured and the results are shown in FIG. 6. The discharge delay time was measured in the same manner as in Measurement Example 1.

Referring to FIG. 6, graphs represented by -▴-, -▪- and -●- illustrates discharge delay times at 60° C., 25° C. and −10° C., respectively.

Samples 6 through 9 according to the present invention had excellent discharge delay time and dependency of the discharge delay time on temperature. In particular, when the amount of Ni was 200 ppm, that is, when Sample 7 was used, the discharge delay time at 60° C. was about 1010 ns which was smallest among those of Samples 6 through 9.

### Manufacture Example 10

A discharge cell was produced in the same manner as in Manufacture Example 3, except that more Ni (NO₃)₂, of which amount was controlled to be 2.0×10⁻⁴ g based on 1 g of the magnesium oxide, was added to form a composite for forming a protecting layer, and ultimately, a protecting layer in which the amount of Mg was 2.0×10⁻⁴ and the amount of Ni was 2.0×10⁻⁴ based on 1 g of the magnesium oxide (that is, the amount of Cu was 200 ppm and the amount of Ni was 200 ppm based on 1 g of the magnesium compound) was obtained. The discharge cell will be referred to Sample 10.

### Comparative Example A

A discharge cell was produced in the same manner as in Manufacture Example 10, except that a protecting layer was formed using a monocrystalline MgO instead of the composite for forming a protecting layer of Manufacture Example 10. The discharge cell will be referred to as Sample A.

### Measurement Example 3

### Discharge Delay Time of Samples 10 and A

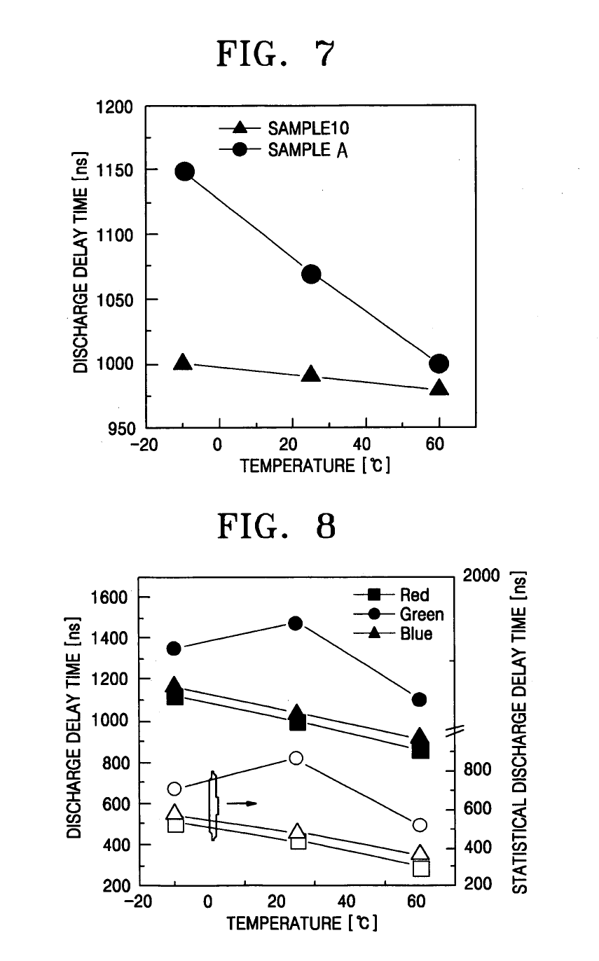

The discharge delay times (unit: ns) with respect to temperature of Samples 10 and E were measured and the results are shown in FIG. 7.

Referring to FIG. 7, the discharge delay time of Sample A was significantly changed in the range of about 1000 ns to 1150 nm as temperature decreased, but dependence of the discharge delay time of Sample 10 on temperature was substantially small. In addition, at room temperature, the discharge delay time of Sample 10 was improved to about 980 ns.

As a described, Sample 10 had very small discharge delay time and dependence of the discharge delay time on temperature was low. Therefore, it was confirmed that Sample 10 was suitable for responding to the increase of the amount of Xe and the single scan.

### Example 1

### Manufacture of Panel Including Protecting Layer According to an Embodiment of the Present Invention

Manufacture of Panel

MgO, Cu(NO₃)₂ and Ni(NO₃)₂, of which amounts were controlled such that the amount of Cu was 2.0×10⁴ g and the amount of Ni was 2.0×10⁻⁴ g based on 1 g of a magnesium oxide, were mixed and stirred for 5 hours or greater in a mixer to produce a homogenous mixture. MgF₂ as a flux was added to the mixture and heat treated at 900° C. for 5 hours in a melting pot. The heat-treated result was compressively molded in a form of a pellet, and heat treated at 1650° C. for 3 hours to produce a composite for forming a protecting layer containing 2.0×10⁻⁴ g of Cu and 2.0×10 ⁻⁴ g of Ni based on 1 g of the magnesium oxide.

Separately, an address electrode was formed using photolithography on a 2 mm-thick glass substrate. The address electrode was covered with a PbO glass to form a rear dielectric layer with a thickness of 20 μm. Then, the rear dielectric layer was covered with red, green, and blue emissive fluorescence to prepare a rear substrate.

A bus electrode formed of Cu was formed using photolithography on a 2 mm-thick glass substrate. The bus electrode was covered with a PbO glass to form a front dielectric layer with a thickness of 20 μm. Then, the composite for forming the protecting layer as a deposition source was deposited on the dielectric layer by e-beam evaporation to form a protecting layer of which the amount of Cu was 2.0×10⁻⁴ g and the amount of Ni was 2.0×10⁻⁴ g based on 1 g of the magnesium oxide 1 g (that is, the amount of Cu was 200 ppm and the amount of Ni was 200 ppm based on 1 g of the magnesium oxide.) When the composite was deposited to form the protecting layer, the temperature of the substrate was 250° C., and the deposition pressure was adjusted to 6×10⁻⁴ torr by adding oxygen gas and argon gas through a gas flow controller. As a result, a front substrate was manufactured.

The front substrate and the rear substrate were arranged such that the front substrate faces the rear substrate in a distance of 130 μm, thus forming a cell. A gaseous mixture of Ne 95% and Xe 5% as a discharge gas was injected to the cell, thereby forming a 42-inch SD V3 PDP, which will be referred to as Panel 1. Amounts of Cu and Ni of the protecting layer of Panel 1 were measured using SIMS. The SIMS analysis method was identical to the method of measuring the amount of Cu of Manufacture Example 1.

As a result of the SIMS analysis, in the protecting layer of Panel 1, the amount of Cu was 2.0×10⁻⁴ g and the amount of Ni was 2.0×10⁻⁴ g based on 1 g of the magnesium oxide (that is, the amount of Cu was 200 ppm and the amount of Ni was 200 ppm).

### Comparative Example B

A panel was produced in the same manner as in Example 1 except that the deposition source was a monocrystalline MgO instead of the composite for forming the protecting layer described in Example 1. The panel will be referred to as Panel B.

### Measurement Example 4

### Discharge Delay Times of Panels 1 and B

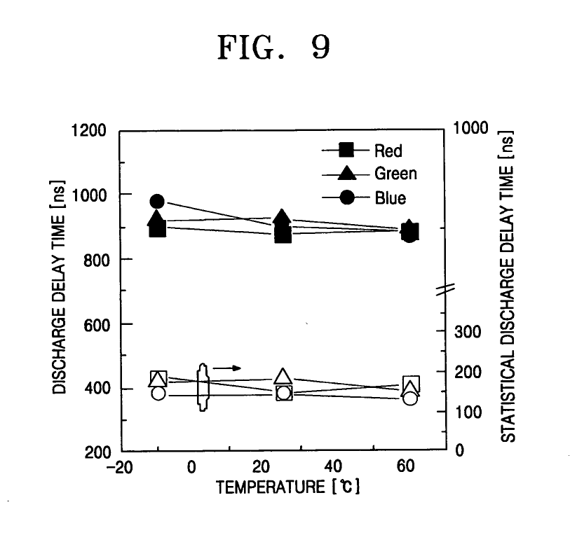

Discharge delay times of Panel B and Panel 1 were measured using a photosensor, an oscilloscope, and a temperature transmitter, and the results are shown in FIG. 8 and FIG. 9, respectively.

Referring to FIGS. 8 and 9, graphs represented by -▪-, -●- and -▴- illustrate discharge delay times of red, green and blue pixels, respectively, and graphs represented by -□-, -◯- and -Δ- illustrate statistical discharge delay times of red, green, and blue pixels, respectively.

Referring to FIG. 8, the discharge delay time and the statistical discharge delay time of Panel B were significantly changed with respect to temperature, confirming a high dependency on temperature. In detail, the discharge delay times of Panel B at −10° C., 25° C. and 60° C. were in the range of about 850 ns to about 1500 ns.

On the other hand, referring to FIG. 9, the discharge delay time and statistical discharge delay time of Panel 1 were not substantially changed with respect to temperature. In detail, the discharge delay times of Panel 1 at −10° C., 25° C. and 60° C. were in the range of about 900 ns to about 1050 ns. Among red, green, blue pixels, green and blue pixels had a constant discharge delay time of about 900 ns at this temperature range. As described above, Panel 1 including the protecting layer according to the present invention had a short discharge delay time and less dependency of the discharge delay time on temperature, and thus, Panel 1 had discharge characteristics suitable for responding to the increase of the amount of Xe and the single scan.

Since a protecting layer according to the present invention contains a copper component and/or a nickel component and/or a cobalt component and/or an iron component, the protecting layer is suitable for responding to the increase of the amount of Xe and a single scan, contrary to a protecting layer of a PDP formed of a monocrystalline MgO only. When a protecting layer of a gas discharge display device, in particular, of a PDP is formed of a composite according to the present invention, an electrode and a dielectric layer can be protected from a plasma ion formed by discharge of a gaseous mixture of Ne and Xe, or a gaseous mixture of He, Ne and Xe; the discharge voltage decreases; and discharge delay time reduces. The protecting layer can hinder an increase of the discharge voltage due to an increase of the amount of Xe, which is used to obtain high brightness, and a decrease of PDP lifetime due to addition of a He gas.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A protecting layer, comprising:
a magnesium oxide; and
at least one additional component selected from the group consisting of a copper component, a nickel component, a cobalt component, and an iron component.

2. The protecting layer of claim 1, wherein the copper component is selected from the group consisting of copper and a copper oxide, and the nickel component is selected from the group consisting of nickel and a nickel oxide, the cobalt component is selected from the group consisting of cobalt and a cobalt oxide, and the iron component is selected from the group consisting of iron and an iron oxide.

3. The protecting layer of claim 1, wherein the at least one additional component contains the copper component.

4. The protecting layer of claim 1, wherein the at least one additional component contains the nickel component.

5. The protecting layer of claim 1, wherein the at least one additional component contains the cobalt component.

6. The protecting layer of claim 1, wherein the at least one additional component contains the iron component.

7. The protecting layer of claim 1, further formed of an aluminum component selected from the group consisting of aluminum and an aluminum oxide.

8. The protecting layer of claim 1, wherein the amount of the at least one additional component is in the range of 5.0×10⁻⁵ to 1.0×10⁻³ parts by weight based on 1 g of the magnesium oxide.

9. The protecting layer of claim 3, wherein the amount of the copper component is in the range of 5.0×10⁻⁵ to 6.0×10⁻⁴ parts by weight based on 1 part by weight of the magnesium oxide.

10. The protecting layer of claim 4, wherein the amount of the nickel component is in the range of 1.0×10⁻⁴ to 6.0×10⁻⁴ parts by weight based on 1 part by weight of the magnesium oxide.

11. The protecting layer of claim 5, wherein the amount of the cobalt component is in the range of 1.0×10⁻⁴ to 6.0×10⁻⁴ parts by weight based on 1 part by weight of the magnesium oxide.

12. The protecting layer of claim 6, wherein the amount of the iron component is in the range of 1.0×10⁻⁴ to 6.0×10⁻⁴ parts by weight based on 1 part by weight of the magnesium oxide.

13. The protecting layer of claim 7, wherein the amount of the aluminum component is in the range of 1.0×10⁻⁴ to 6.0×10⁻⁴ parts by weight based on 1 part by weight of the magnesium oxide.

14. The protecting layer of claim 1, wherein the magnesium oxide is a polycrystalline magnesium oxide.

15. A plasma display panel having the protecting layer of claim 1.

16. A composite for forming a protecting layer, the composite comprising:
a magnesium oxide derived from at least one magnesium-containing compound selected from the group consisting of a magnesium oxide and a magnesium salt;
at least one additional component selected from the group consisting of a copper component derived from at least one copper-containing compound selected from the group consisting of a copper oxide and a copper salt, a nickel component derived from at least one nickel-containing compound selected from the group consisting of a nickel oxide and a nickel salt, a cobalt component derived from at least one cobalt-containing compound selected from the group consisting of a cobalt oxide and a cobalt salt, and an iron component derived from at least one iron-containing compound selected from the group consisting of an iron oxide and an iron salt; and
optionally an aluminum component derived from at least one aluminum-containing compound, the aluminum-containing compound selected from the group consisting of an aluminum oxide and an aluminum salt.

17. The composite of claim 16, wherein the at least one additional component contains the copper component.

18. The composite for claim 16, wherein the magnesium salt is selected from the group consisting of MgCO₃ and Mg(OH)₂; the copper salt is selected from the group consisting of CuCO₃, CuCl₂, Cu(NO₃)₂ and CuSO₄; the nickel salt is selected from the group consisting of NiCl₂, Ni(NO₃)₂ and NiSO₄; the cobalt salt is selected from the group consisting of CoCl₂, Co(NO₃)₂ and CoSO₄; and the iron salt is selected from the group consisting of FeCl₂, Fe(NO₃)₂ and FeSO₄.

19. The protecting layer of claim 16, wherein the magnesium oxide is a polycrystalline magnesium oxide.

20. A plasma display panel having the protecting layer formed of the composite of claim 16.

21. A method of forming a protecting layer, the method comprising:
(a) homogenously mixing at least one magnesium-containing compound selected from the group consisting of a magnesium oxide and a magnesium salt, with at least one compound selected from the group consisting of a copper-containing compound selected from the group consisting of a copper oxide and a copper salt, a nickel-containing compound selected from the group consisting of a nickel oxide and a nickel salt, a cobalt-containing compound selected from the group consisting of a cobalt oxide and a cobalt salt, and an iron-containing compound selected from the group consisting of an iron oxide and an iron salt to produce a mixture;
(b) calcinating the mixture;
(c) sintering the calcinated mixture to form a composite; and
(d) forming the protecting layer using the composite.

22. The method of claim 21, wherein the mixing is performed using MgF₂ as a flux.

23. The method of claim 21, wherein the calcination is performed at a temperature of 400° C. to 1,000° C.

24. The method of claim 21, wherein the sintering is performed at a temperature of 1,000° C. to 1,750° C.

25. The method of claim 21, wherein the formation of the protecting layer is performed using at least one method selected from the group consisting of a chemical vapor deposition (CVD) method, an e-beam deposition method, an ion-plating method, and a sputtering method.

26. The protecting layer of claim 21, wherein the magnesium oxide is a polycrystalline magnesium oxide.

27. The protecting layer formed by the method of claim 21.
